(19) United States
(12) Patent Application Publication
(10) Pub. No.: US 2007/0163519 A1
(43) Pub. Date: Jul. 19, 2007

(54) Noose release lock for animals snare

(76) Inventor: Richard L. Sinrud, Lynnwood, WA (US)

Correspondence Address: DOWREY RICKARDS, 19119 NORTHCREEK PARKWAY, SUITE 106, BOTHELL, WA, 98011, US

(21) Appl. No.: 11/648,032

(22) Filed: Dec. 29, 2006

Related U.S. Application Data
(60) Provisional application No. 60/759,815, filed on Jan. 17, 2006.

(51) Int. Cl. A01K 15/04

(52) U.S. Cl. 119/802

(57) ABSTRACT

A release lock for a snare uses a release element mounted so that the cable forming the noose of the snare will open when the tension applied to the cable exceeds the design strength of the release element. The cable may be placed in a slot in the body of the release lock with the release element being retained between the cable and the body. Various parameters of the body, release element, cable, slot and other elements of the release lock may be varied to adjust the resistance to sliding of the release lock along the cable so that live capture of the target species may be achieved.

### CROSS REFERENCE TO RELATED APPLICATIONS

This application claims priority based on applicant's copending U.S. Provisional Patent Application No. 60/759,815, filed Jan. 17, 2006, which is incorporated herein by this reference.

### BACKGROUND

The practice of animal trapping using snares extends back into antiquity. Simple snares were designed to tighten around the neck, body or an appendage of the target animal, and remain tight. Most snares in use today are made using stranded wire, wire cable and the like (hereinafter collectively referred to as “cable”). Other flexible materials, such as resilient plastic line, composite line and the like might be used as a cable within the meaning of that term for purposes hereof. The cables may be looped around or otherwise affixed at one end to an anchor comprising a fixed or heavy object capable of adequately withstanding tension on the snare cable, such as a tree or other natural feature of the landscape, or to a stake or other man-made objects, or may be otherwise secured. The other end may be looped to form a noose that tightens when the head or other appendage of an animal is inserted into it and pulls at the noose. Capture around the neck with a simple snare that does not allow the noose to relax may result in asphyxiation of the animal as it struggled to pull free of the snare.

Snares may also capture animals other than the target species for which the snare was intended. For example, a bear, deer or domestic animal may be captured by a snare set for the capture of coyotes. Such non-target animals may be harmed by the snare if they are not successful in freeing themselves. A release mechanism that allows escape by animals that are larger or stronger than the target animals can prevent such unintended consequences.

Simple and release snares may be set in various ways depending on the user's preferred method of setting. A release lock allows for the noose to break apart or otherwise release the captured animal once the release tension has been applied by the animal. This allows the snare to capture certain species while allowing a larger or heavier species to release itself from the snare and become free without significant harm to the animal. Many states require the use of release snares for trapping. The release force limits mandated by the state laws vary among the states, and are subject to change over time. Many states have live-capture requirements that require that the snare be able to slacken somewhat upon the release of tension. Such relax function has been incorporated in prior snares at the cost of added complexity.

Although release snares are known, many incorporate elements mounted to the means forming the noose closure (the “body”) that are frangible or that are deformed when a release occurs. In order to reset the snare, it must thus often be remanufactured or repaired. Where remanufacture in the field is allowed, such remanufacture may require the trapper to carry tools and snare component parts that may be heavy, bulky and difficult to use in the field. Where remanufacture must be carried out by the manufacturer of the snare or other suitable shop, the snare must be packed out and will thus remain out of service for a period of time. A need therefore exists for a snare that may be reset in the field without the need for heavy or bulky tools or complicated remanufacturing processes, and that, in other manners, can meet the needs of the users of snares.

### BRIEF DESCRIPTION OF THE DRAWINGS

FIG. 1 is an isometric view of a snare using a release lock with one cable end and a ferrule shown in phantom.

FIG. 2 is an isometric view of a release lock mounted to a cable and having a slot with rounded ends.

FIG. 3 is an isometric view of a release lock mounted to a cable and having a slot with one rounded end and one angled end.

FIG. 4 is a top plan view of the body of the release lock of FIG. 2 prior to bending.

FIG. 5 is a top plan view of the body of the release lock of FIG. 3 prior to bending.

FIG. 6 is a side elevation of the body of the release lock of FIG. 2 with other bend angles shown in phantom.

FIG. 7 is a side elevation showing various forms of release elements that may be used.

FIG. 8 is a cross-sectional view showing various cross-sectional shapes that may be used for release elements.

### DETAILED DESCRIPTION

A release snare according to one embodiment of the invention may provide a releasing mechanism that may be reset after release in the field by insertion of a new release element 9. The release snare may use a release element 9 that may be changed to set the release tension.

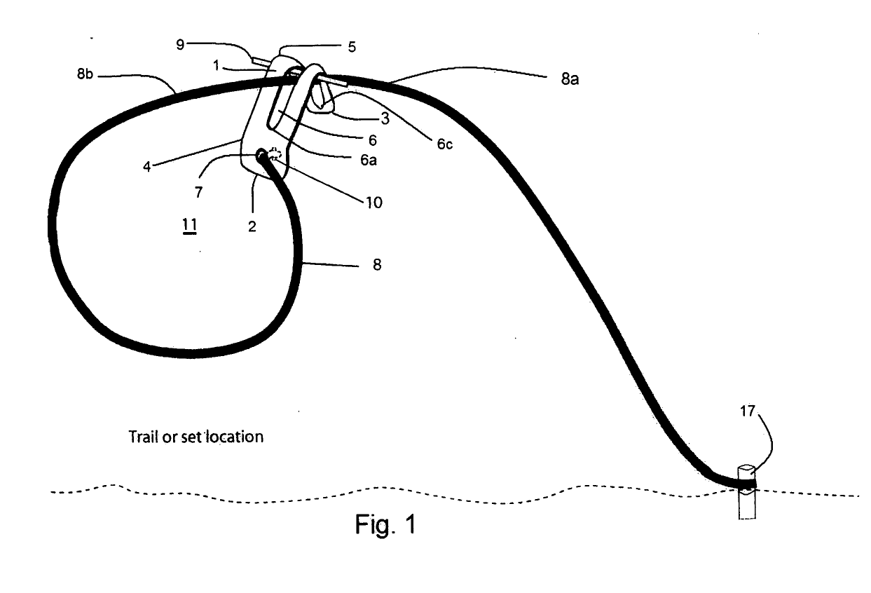

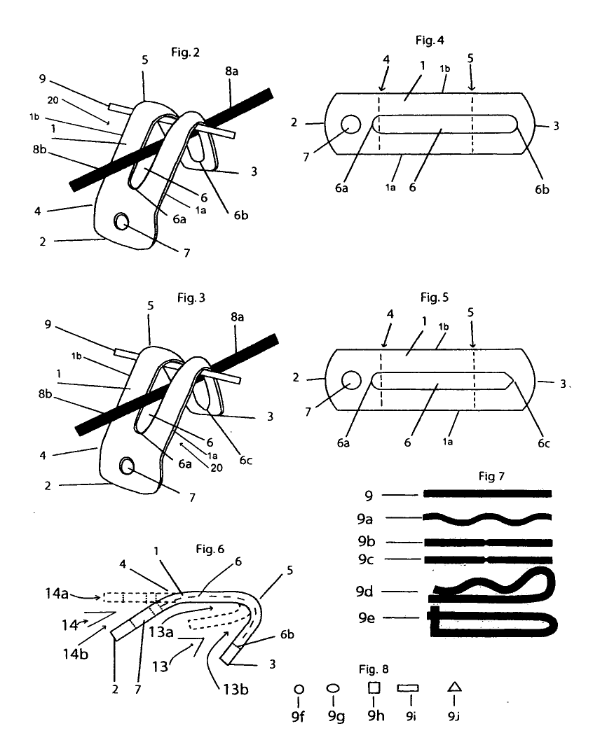

Referring to FIGS. 1-3, according to one embodiment, a release snare may comprise a release lock 20 that, in turn, comprises a body 1. The body 1 may be made of any suitable material having sufficient strength and rigidity to avoid deforming under the anticipated loads to the extent that its function is impaired. For example, according to an embodiment, the body 1 is made of metal, such as, for example, steel, and may be formed by casting, molding, stamping, machining, bending and other methods for working such metal, as will be apparent to those familiar with the metal-working arts. The body may be treated to resist oxidation or the like, as, for example, by painting, coating or galvanization of steel. The body 1 and release element 9 together may form a release lock/noose closure, with the release element 9 being captured between the back side of the body 1 and the cable 8.

Referring to FIGS. 1-6, first and second ends 2, 3 of the body 1 of the release lock 20 may be rounded to reduce the risk of penetrating or cutting the hide of a captured animal or cutting or scraping off its hairs. In one embodiment, the side edges 1a and 1b of the body 1 of the present embodiment extend between the first and second ends 2, 3 of the body 1, and are generally equally spaced from one another along their lengths. A slot 6 or other aperture capable of receiving the cable 8 having first and second slot ends 6a, 6b (or 6c as shown in FIGS. 3 and 5) is provided in the body and extends over part of the length of the body 1 in between the two side edges 1a, 1b. The width of the slot 6 is chosen to accommodate cables within the desired range of cable diameters. An aperture 7 is provided near the forward end 2 of the body 1, and is of sufficient size that a cable 8 of the desired diameter can fit through it.

In one embodiment, referring in particular to FIG. 1, the cable 8 is terminated by a ferrule 10 (shown in phantom) that is fastened adjacent one end of the cable 8 (also shown in phantom. The ferrule 10 has a diameter greater than that of the aperture 7 in the body 1, and resists the pulling of the cable 8 back out of the aperture 7 in the body. Other means, such as, for example, cable clamps, brazed fittings, and other methods of forming, deforming or anchoring of the cable may be used. The cable 8 may be bent in an arc where it passes through the aperture 7, if desired, in order to permit the noose 11 of the snare to assume a more rounded shape.

Referring to FIGS. 1-6, according to an embodiment, a first bend position 4 (indicated generally by the line 4) is provided in the body 1 proximate to the first end 2 of the body 1 and between the aperture 7 and the first end 6a of the slot 6. The bend position 4 (indicated generally by line 4) along which the body 1 may be bent, is best shown in FIGS. 4 and 5. It extends across the body and may be generally perpendicular to the long axis of the body 1.

The angle of the bend in the first bend region 4 may be selected with a view to accommodating the size and stiffness of the cable and the dimensions of the body 1 and may be chosen to affect the tension on the release element 9 applied by the cable 8 when an animal is captured by the snare. The bend angle 14 may be 0° (no bend). Bend angles 14 of 5° (14a), shown by the portion of the body 1 presented in phantom, and 30° (14b) are depicted in FIG. 6, and the angle may be chosen, for example angles 14 of between 0° and 30°, to affect the function of the release lock 20 and facilitate the bending of the cable 8 to form a more-rounded noose 11.

A second bend position 5 (indicated generally by the line 5) may be provided between the ends 6a and 6b (or 6c) of the slot 6. Bend angles 14 of 5° (13a) and 80° (13b) are depicted in FIG. 6, and the bending may be accomplished along the bend line 5, for example. The distance of the bend in this bend position 5 from the first end 6a and second end 6b (or 6c), as shown in FIGS. 1-6, and the angle 13 of the bend, may be chosen to affect the pressure applied by the cable to the release element 9. When the bend in the body 1 in the bend region 5 is bent between 5° (see, e.g., the angle 13a in FIG. 6) and 45°, the resistance to the cable 8 sliding through the slot 6 in the body 1 is lower. When the angle 13 in the bend region 5 is between 30° and 80° (see, e.g., the angle 13b in FIG. 6), the cable 8 will slide less freely through the body 1 in the direction of the section 8a of the cable. When the bend angle 13 in the bend region 5 is from 35° to 80° (see, e.g., angle 13b), it may be desired to provide an angular end 6c in the slot 7 to provide additional resistance to the body 1 sliding along the cable 8 in the direction of cable section 8a, allowing the noose 11 to expand.

While some loosening of the noose 11 by such sliding of the release lock 20 may be desired to allow live capture of the target animals, as may be required by law, excessive sliding may allow the noose 11 to expand too much, and may thus result in the escape of the captured animal. The more rounded end 6b is less restrictive, and allows the cable 8 to slide through the body 1 more easily so that the noose 11 slackens more easily. The end 6c, shown in FIGS. 3 and 5, by contrast, provides greater resistance to sliding of the release lock 20 in the direction of the cable section 8a, with the attendant greater resistance to slackening of the noose 11.

In another embodiment, the bend in the bend region 5 of the body 1 is moved closer to the second end 3 of the body 1, making the distance between the bend and the end 6b of the slot 6 shorter. This may be chosen in order to increase the resistance of the release lock 20 from sliding in the direction of cable section 8a, resulting in expansion of the noose 11. In other embodiments, the bend position is moved away from the end 6b of the slot 6 with the result that the release lock 20 slides more freely in the direction of cable section 8a. The bend angle 14 and the position of the bend position 4 may also be varied to affect the tension applied to the cable by the release element 9. Use of a rougher or coarser cable 8 may increase the resistance of the release lock 20 to such sliding, and use of a smooth and/or fine cable may decrease the resistance. The resistance to sliding of the release lock 20 may also be affected by the stiffness or flaccidity of the cable 8.

Referring to FIGS. 7 and 8, the release element 9 is bendable or frangible. As shown in FIGS. 7 and 8, the release element may be straight. The degree of resistance to breaking or bending of the release element will vary according to the strength of the chosen material and the diameter of the release element 9. Release elements may be made, for example, from mild steel. As shown in FIGS. 3 and 7, the length of the release element 9 is sufficient to span the slot 6 and engage the body. The length of the release element 9-9e may be greater than the width of the body 1.

Other configurations of the release element 9 may also be used. For example, the release element 9a has an undulating or wavy form that may allow the cable 8 to saddle itself within a valley. This helps the release element 9a remain centered in the body 1. The release elements 9b and 9c include “V”- or “U”-shaped grooves intermediate their ends. When used with a thin cable 8 of, for example 1/32 inch diameter, a 3/64 inch groove may allow the cable to saddle therein, contributing to the positional stability of these release elements 9 relative to the body. Larger cables 8 may also engage the groove. The grooves may contribute to the bendability or frangibility of the release elements 9b and 9c.

In other forms, the release element 9 may be bent or otherwise formed so that it may be extended across both sides of the body. The release element 9d is in the shape of a cotter pin, and may be positioned with either the undulating or straight portion between the cable 8 and the body 1. The release element 9e may be bent or formed to have two relatively straight sides, with the free end of one of the sides being further bent or formed to contact or terminate proximate the other of the sides so that it can be secured around the body 1.

The release elements 9-9e may also be formed to have any of a variety of cross-sectional shapes, such as those shown in FIG. 8. The release elements 9-9e may, for example, have cross-sectional shapes 9f-9j that are round, oval, square, rectangular or triangular cross sectional shapes. The more angular shapes, such as 9j, may be chosen to exert greater resistance to the sliding. The release elements 9 may also be color coded to indicate the force necessary for the release element 9 to bend or break in order to release a larger and/or stronger animal than the target species. The release elements 9 may be made of metal or other appropriate material

Snares according to the various embodiments described above may be set in various ways depending on the user's preferred method of setting, and may be anchored to a stake, a rock of sufficient mass, a tree or other object that can resist the pulls of the target species. When an animal is caught in the noose 11 and tries to pull free, the tension applied by the animal results in greater tension being exerted on the release element 9 by the cable. The noose 11 tightens around and compresses the animal's neck (or other part of the animal) as the release lock 20 slides along the cable 8 toward the cable section 8b. As the animal ceases to apply tension, the spring in the cable 8 forming the noose 11 and the expansion force of the animal's neck or other body part captured by the noose 11 may cause the release lock 20 to slide in the direction of section 8a of the cable 8 as the noose 11 expands, thus relieving some of the compressive force of the noose 11 on the portion of the body of the animal that it encircles.

If an animal caught in the noose 11 of the snare exerts a tension greater than the design tension of the release element 9, the release element will bend or break, allowing the cable 8 to be pulled out of the slot, thereby releasing the animal. For example, as the animal applies a sufficient tension to the cable, the cable will attempt to pull out of the slot 6 in the body 1. As this occurs, the release element 9, that is positioned between the cable 8 and the body 1, will break or bend around the cable 8 until the cable 8 is pulled through the slot 6. At that point, the body 1 remains attached to the end of the cable 8 that extends through the aperture 7 in the body 1. As the cable 8 has pulled out of the slot 6 in the body 1, the noose 11 is opened and the animal is released. The bend or break strength of the release element 9 governs the release tension. This allows the snare to capture certain species while allowing a stronger or heavier animal than the target species to release itself from the snare and become free.

If the user returns to find that the noose 11 has released, the snare may be reset by inserting the cable 8 back into the slot, and placing a release element 9 of the desired configuration and cross-section (see FIGS. 7 and 8) so that it (or a portion of it, particularly with reference to release elements 9d and 9e) extends between the body 1 and the cable 8.

Although a number of embodiments have been described above, other embodiments are possible. Therefore, the spirit or scope of the invention should not be limited to the description of the embodiments contained herein.

I claim:

1. A release lock for a snare comprising:
a body attachable adjacent one end to a cable, the body including an aperture into which a length of cable may be inserted; and
a release element positionable to extend across the aperture transversely to the length of cable and being insertable between one side of the body and a cable inserted into the aperture to retain the cable in engagement with the body.

2. The release lock of claim 1 wherein the release element comprises an elongated deformable member having a design strength such that the release element breaks upon application of tension to a cable inserted into the aperture of the release lock that is greater than a release tension.

3. The release lock of claim 1 wherein the release element comprises an elongated frangible member having a design strength such that the release element breaks upon application of tension to a cable inserted into the aperture of the release lock that is greater than a release tension.

4. The release lock of claim 1 wherein the aperture in the body comprises a slot having first and second ends.

5. The release lock of claim 4 wherein the second end of the slot is rounded.

6. The release lock of claim 4 wherein the second end of the slot is angular.

7. The release lock of claim 4 wherein the body is formed with a bend in a second bend position along a bend line transverse to the slot intermediate its first and second ends.

8. The release lock of claim 7 wherein the body is formed with a bend in a first bend position along a bend line extending transverse to a long axis of the body at a location between the first end of the body and the bend line in the second bend region.

9. The release lock of claim 8 wherein the body further includes a second aperture adjacent the first end thereof and intermediate the first end of the body and the bend line in the first bend position.

10. The release lock of claim 7 wherein the angle of the bend in the second bend position of between five and eighty degrees.

11. The release lock of claim 8 wherein the angle of the bend in the first bend position is between zero and thirty degrees.

12. A release lock comprising:
a body having a long axis, the body having first and second ends and being formed with bends transverse to its long axis at first and second bend positions;
a slot extending along a portion of the body in the direction of the long axis, the slot having first and second ends and being positioned such that the second bend position falls intermediate the ends of the slot; and
a cable attachment point adjacent the first end of the body, the attachment point being intermediate the first end of the body and the first bend position, and the first bend position being intermediate the attachment point and the second bend position.

13. The release lock of claim 12 wherein the angle of the bend at the first bend position being between zero and thirty degrees, and the bend angle at the second attachment point being between five and eighty degrees.

14. The release lock of claim 12 wherein the second end of the slot is rounded.

15. The release lock of claim 12 wherein the second end of the slot is angular.

16. A method of forming a release lock snare comprising:
providing a body having first and second ends;
providing a slot in the body intermediate its first and second ends, the slot also having first and second ends;
providing a second bend in the body along a bend line transverse to a line between the first and second ends of the body;
providing an attachment point on the body intermediate the first end of the body and the first end of the slot;
attaching a cable to the body at the attachment point;
inserting a portion of the cable through the slot;
positioning a frangible or bendable release element such that it extends transversely across the slot and between the body and the cable to retain the cable in the slot.

17. The method of claim 16 further comprising providing a first bend in the body along a first bend line transverse to a line between the first and second ends of the body.

18. The method of claim 17 wherein the second end of the slot is formed to be rounded.

19. The method of claim 18 wherein the second end of the slot is formed to be angular.
The method of claim 17 wherein the bend angle at the first bend position is between zero and thirty degrees and wherein the bend at the second bend position is between five and eighty degrees.
